(19) United States
(12) Patent Application Publication
(10) Pub. No.: US 2004/0141317 A1
(43) Pub. Date: Jul. 22, 2004

(54) Flashlight

(75) Inventor: Pei-Chang Sun, Taichung (TW)

Correspondence Address: BROWDY AND NEIMARK, P.L.L.C., 624 NINTH STREET, NW, SUITE 300, WASHINGTON, DC, 20001-5303, US

(73) Assignee: Modern Pioneer Ltd., Taichung (TW)

(21) Appl. No.: 10/347,605

(22) Filed: Jan. 22, 2003

(51) Int. Cl. F21L 4/04

(52) U.S. Cl. 362/198; 362/199; 362/208

(57) ABSTRACT

A flashlight includes a first barrel holding a battery, a second barrel detachably coupled to the first barrel and holding a bulb, a collapsible tube connected between the first barrel and the second barrel to electrically connect the battery to the bulb and to let the second barrel to be moved away from the first barrel at a distance and turned to the desired angle and direction, and a third barrel holding a reflector and a lens and coupled to the second barrel and axially movable between a first position for enabling the light of the bulb to be projected out of the lens of the third barrel and a second position for enabling the light of the bulb to pass radially through the periphery of the second barrel.

### BACKGROUND OF THE INVENTION

1. Field of the Invention

The present invention relates generally to a flashlight, and more particularly to such a flashlight that provides multiple operation modes to fit different operational requirements.

2. Description of the Related Art

Conventional flashlights are specifically designed for different purposes, for example, for emergency illumination or for use under water. There are also known multipurpose flashlights, for example, a flashlight with a screwdriver. For different purposes or different occasions, different flashlights may be required. When designing a flashlight, many factors such as the light intensity, the supply of power, the convenience of operation, etc., must be taken into account. When purchasing a flashlight, a consumer may consider first if the function of the flashlight fits one's operational requirement.

### SUMMARY OF THE INVENTION

It is the main object of the present invention to provide a flashlight, which provides multiple operation modes to fit different operational requirements.

It is another object of the present invention to provide a flashlight, which has the bulb connected to the body of the flashlight through a collapsible tube so that the user can turn the bulb to any desired angle and direction.

It is still another object of the present invention to provide a flashlight, which can be set between a first position to project light axially forwards in the form of a light beam, and a second position to let light pass radially sideways.

To achieve these objects of the present invention, the flashlight comprises a casing having a first barrel, a second barrel, and a third barrel. The first barrel has a grip around the periphery thereof, an inside battery chamber, and an inside receiving chamber in front of the battery chamber. The second barrel is detachably connected to a front side of the first barrel and has a front half section that admits light. The third barrel is connected to the second barrel and axially movable on the second barrel between a first position where the third barrel keeps the front half section of the second barrel from sight and a second position where the front half section of the second barrel is exposed to the outside. The third barrel has a lens in a front side thereof. A light emitting device is mounted inside the second barrel. Battery means is installed in the battery chamber of the first barrel and adapted to provide electricity to the light emitting device to cause the light emitting device to emit light. A reflector is mounted inside the third barrel and adapted to reflect light from the light emitting device into a light beam through the lens of the third barrel when the second barrel moved to the first position. A collapsible connecting tube is connected between a part inside the receiving chamber of the first barrel and the second barrel. The collapsible connecting tube is received inside the receiving chamber of the first barrel when the second barrel connected to the front side of the first barrel.

### BRIEF DESCRIPTION OF THE DRAWINGS

FIG. 1 is a schematic drawing showing the outer appearance of a flashlight according to the present invention;

FIG. 2 is a sectional assembly view of the present invention, showing light projected out of the front side of the flashlight,

FIG. 3 is a schematic drawing, partially in section, of the present invention, showing light emitted sideways from the flashlight; and

FIG. 4 is a schematic drawing showing another status of use of the flashlight according to the present invention.

### DETAILED DESCRIPTION OF THE INVENTION

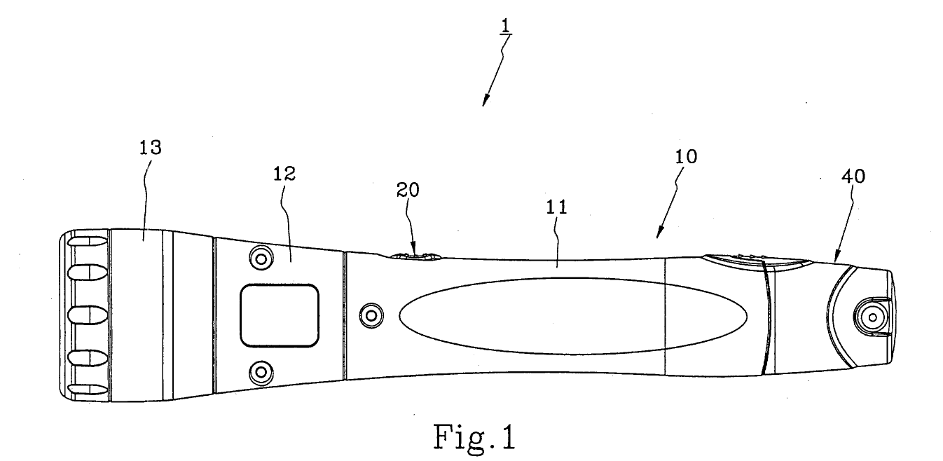

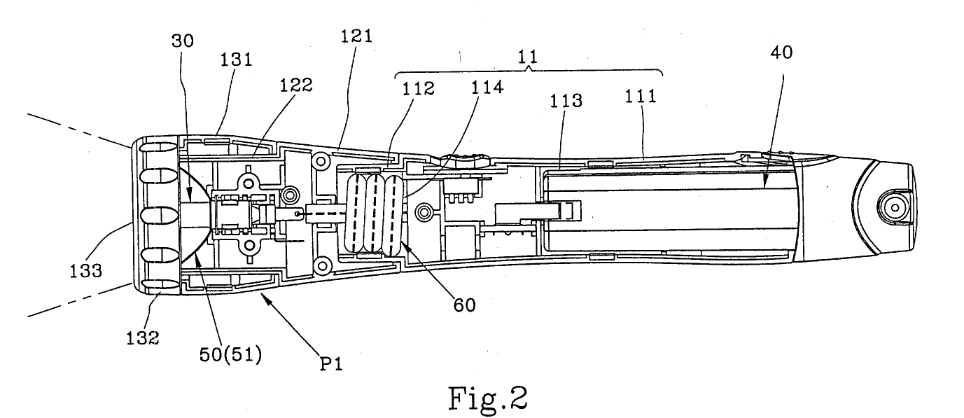

As shown in FIGS. 1-2, a flashlight 1 is shown comprised of a casing 10, a switch 20, a light emitting device, for example, a bulb 30, a battery 40, a reflector 50, and a collapsible connecting tube 60.

The casing 10 is comprised of a first barrel 11, a second barrel 12, and a third barrel 13 detachably connected to one another in a line. The first barrel 11 is a cylindrical double-open-end member having a grip 111 around the periphery for the holding of the user's hand, a front coupling neck 112, a battery chamber 113 axially extended in the rear side, a receiving chamber 114 defined within the front coupling neck 112 in front of the battery chamber 113. The switch 20 is located on the periphery of the first barrel 11 near the front coupling neck 112.

The second barrel 12 has a rear half section 121 and a front half section 122. The rear half section 121 fits the profile of the first barrel 11, and is detachably press-fitted onto the front coupling neck 112. The front half section 122 is shaped like a straight tube that admits light. Further, the front half section 122 can be made having any of a variety of colors.

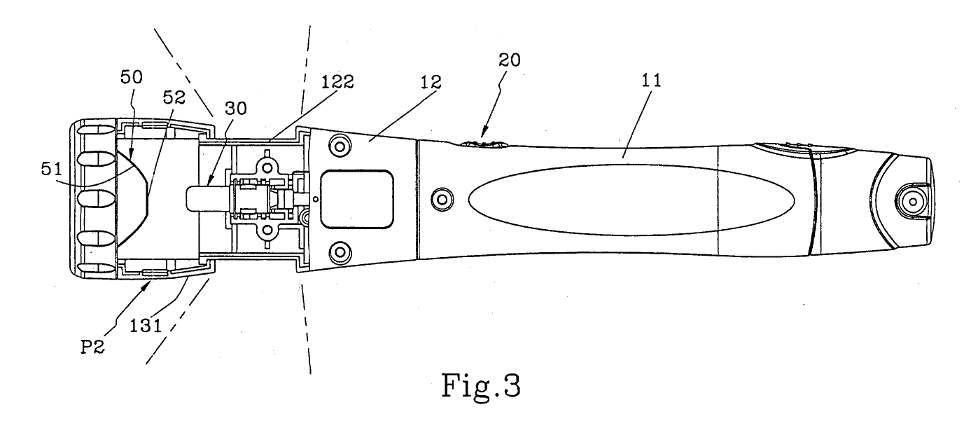

The third barrel 13 comprises a body 131 and a head 132. The body 131 is coupled to the front half section 122 of the second barrel 12 in such a manner that the third barrel 13 can be moved axially along the front half section 122 of the second barrel 12 between a first position P1 where the body 131 is closely attached to the front side of the rear half section 121 and kept the front half section 122 from sight as shown in FIG. 2, and a second position P2 where the body 131 is spaced from the rear half section 121 at a distance and the front half section 122 is exposed to the outside as shown in FIG. 3. The relatively movable connection between the third barrel 13 and the second barrel 12 can be easily achieved by conventional techniques, for example, by a slip joint. Further, the front side of the head 132 forms a lens 133 through which light passes.

The bulb 30 is mounted inside the front half section 122 of the second barrel 12, and axially aimed at the lens 133.

The battery 40 is a cylindrical rechargeable battery that can be plugged into the battery chamber 113 of the first barrel 11 to provide the necessary power to the bulb 30.

The reflector 50 has a conical reflecting face 51 and a center through hole 52 through the center of the conical reflecting face 51. The reflector 50 is fixedly mounted inside the third barrel 13 between the body 131 and the head 132. When the third barrel 13 moved to the first position P1, as shown in FIG. 2, the bulb 30 is inserted through the center through hole 52 of the reflector 50. When the third barrel 13 moved to the second position P2, as shown in FIG. 3, the bulb 30 is disposed behind the reflector 50.

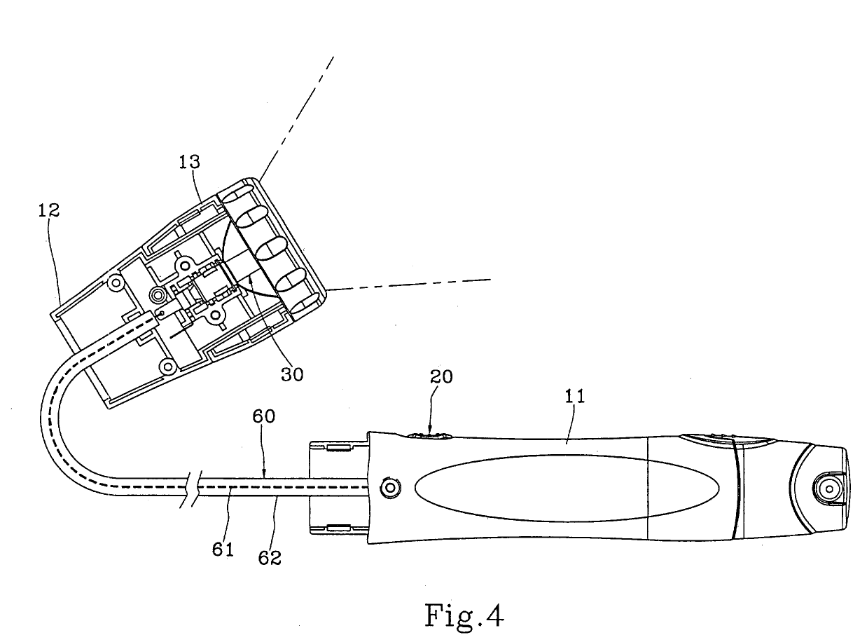

The collapsible connecting tube 60 is comprised of a wire conductor 61 electrically connected between the battery 40 and the bulb 30, and an electrically insulating flexible tube 62 sleeved onto the wire conductor 61 and fixedly connected between the receiving chamber 114 and the second barrel 12 at two ends thereof. When the second barrel 12 connected to the first barrel 11, as shown in FIG. 2, the collapsible connecting tube 60 is received inside the receiving chamber 114. When the second barrel 12 disconnected from the first barrel 11, as shown in FIG. 4, the collapsible connecting tube 60 is extended out of the receiving chamber 114, keeping the second barrel 12 spaced from the first barrel 11.

The flashlight 1 can be use in one of a variety of modes as outlined hereinafter.

With reference to FIG. 2, when the first, second, and third barrels 11, 12 and 13 are connected in a line, the switch 20 is operated to turn on/off the bulb 30. At this time, the conical reflecting face 51 of the reflector 50 reflects the light of the bulb 30 onto the lens 133, and therefore a concentrated light beam is produced and projected out of the lens 133 for the purpose of illumination or searching.

With reference to FIG. 3, the user can pull the third barrel 13 from the first position P1 to the second position P2 when the first and second barrels 11 and 12 maintained connected. At this time, the bulb 30 is disposed behind the reflector 50, and the light of the bulb 30 passes sideways through the front half section 122 of the second barrel 12. Further, the front half section 122 of the second barrel 12 may be frosted to soften the light of the bulb 30.

With reference to FIG. 4, the third barrel 13 and the second barrel 12 can be disconnected from the first barrel 1. At this time, the collapsible connecting tube 60 is pulled out of the first barrel 11, for enabling the third barrel 13 and the second barrel 12 to be turned to any desired angle and direction to illuminate a narrow area where the whole flashlight 1 cannot reach. Further, the collapsible connecting tube 60 can be used to hang the flashlight 1 on a support in the job site so that the user can have the both hands free for working, for example, repairing a vehicle.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A flashlight comprising:
a casing having a first barrel, a second barrel, and a third barrel, said first barrel having a grip around the periphery thereof, an inside battery chamber, and an inside receiving chamber in front of said battery chamber, said second barrel being detachably connected to a front side of said first barrel and having a front half section that admits light, said third barrel being connected to said second barrel and axially movable on said second barrel between a first position where said third barrel keeps the front half section of said second barrel from sight and a second position where the front half section of said second barrel is exposed to the outside, said third barrel having a lens in a front side thereof,
a light emitting device mounted inside said second barrel;
battery means installed in the battery chamber of said first barrel and adapted to provide electricity to said light emitting device to cause said light emitting device to emit light,
a reflector mounted inside said third barrel and adapted to reflect light from said light emitting device into a light beam through the lens of said third barrel when said second barrel moved to said first position; and
a collapsible connecting tube connected between a part inside the receiving chamber of said first barrel and said second barrel, said collapsible connecting tube being received inside the receiving chamber of said first barrel when said second barrel connected to the front side of said first barrel.

2. The flashlight as claimed in claim 1, wherein said first barrel has a front coupling neck formed in the front side; said second barrel has a rear half section axially backwardly extended from said front half section and detachably press-fitted onto the front coupling neck of said first barrel.

3. The flashlight as claimed in claim 2, wherein the front half section of said second barrel is frosted.

4. The flashlight as claimed in claim 3, wherein said light emitting device is mounted inside the front half section of said second barrel.

5. The flashlight as claimed in claim 1, wherein said collapsible connecting tube is comprised of a wire conductor electrically connected between said battery means and said light emitting device, and a flexible tube sleeved onto said wire conductor and fixedly connected between said first barrel and said second barrel.
